(19) United States
(12) Patent Application Publication
(10) Pub. No.: US 2015/0171410 A1
(43) Pub. Date: Jun. 18, 2015

(54) APPARATUS FOR PREVENTING OVER-CHARGE FOR BATTERY OF VEHICLE

(71) Applicant: Hyundai Motor Company, Seoul (KR)

(72) Inventor: Woo Jin SHIN, Seoul (KR)

(21) Appl. No.: 14/330,949

(22) Filed: Jul. 14, 2014

(30) Foreign Application Priority Data
Dec. 18, 2013 (KR) 10-2013-0158752

(51) Int. Cl. H01M 2/34

(52) U.S. Cl. CPC H01M 2/345; H01M 2220/20

(57) ABSTRACT

An apparatus for preventing over-charge for a battery of a vehicle is provided. The apparatus includes an operating part having one end portion on which a catching part is formed, a first contact formed on an upper end of the catching part, and the other end portion contacting a unit battery. A contact part has a locking part formed therein, and the locking part is tightly fixed by the catching part. The contact part includes a second contact contacting the first contact, and is upwardly and elastically supported by an elastic part. An elastic repulsion toward an upper direction is interrupted by fastening the catching part and the locking part. A battery relay turns on and off a battery current and is connected to the first contact and the second contact in a circuit.

### CROSS REFERENCE TO RELATED APPLICATION

This application claims the benefit of priority to Korean Patent Application No. 10-2013-0158752, filed on Dec. 18, 2013, the entire contents of which is hereby incorporated by reference in its entirety into this application.

### TECHNICAL FIELD

The present disclosure relates to an apparatus for preventing over-charge for a battery of a vehicle capable of simply blocking a voltage operating a relay using a swelling force of a cell in a battery module or a battery pack.

### BACKGROUND

The related art controls a battery management system (BMS) so as not to flow a current upon sensing a swelling pressure of a battery cell using a sensor or a wire sensing the swelling pressure of the battery cell. There is a scheme cutting a power line in which a large current flows, such as a lead-tap portion, a bus bar, a welding portion, or the like, when a cell is swelled.

However, since a thickness of the wire or the bus bar is relatively thick, it is difficult to block a current flow by cutting the wire or the bus bar at once.

According to the related art, power is prevented from flowing into a relay via a vehicle or a BMS signal by sensing an over-charge of a cell. In this case, it is premised that a BMS or a vehicle is in a normal state. If the BMS has problems, a situation may occur in which it may be impossible to block the relay.

Therefore, a technology capable of blocking the relay by using only a mechanical method upon cell swelling has been demanded.

The present disclosure simply blocks a voltage operating a relay using a swelling force of a cell in a battery module or a battery pack. By using a special switch employing the swelling force, the relay is generally in an ON state. When a battery is over-charged, a contact of the switch is opened by the swelling force, thus preventing power from being supplied. Thus, according to the present disclosure, a current is prevented from flowing by using the relay which is turned off even in a state in which a BMS or a vehicle is in an abnormal state (the relay itself is in a normal state).

The matters described as the related art have been provided only for assisting in the understanding for the background of the present disclosure and should not be considered as corresponding to the related art known to those skilled in the art.

### SUMMARY

An aspect of the present disclosure provides an apparatus for preventing over-charge for a battery of a vehicle capable of simply blocking a voltage operating a relay by using a swelling force of a cell in a battery module or a battery pack.

According to an exemplary embodiment of the present disclosure, an apparatus for preventing over-charge for a battery of a vehicle includes an operating part having one end portion on which a catching part is disposed, a first contact disposed on an upper end of the catching part, and the other end portion contacting a unit battery. A contact part may have a locking part disposed therein, the locking part being caught by the catching part and includes a second contact contacting the first contact. The contact part may be upwardly and elastically supported by an elastic part, and an elastic repulsion toward an upper direction is interrupted by fastening the catching part and the locking part. A battery relay may turn on and off a battery current and may be connected to an operating power source by joining the first contact and the second contact.

If the operating part is slid due to swelling of the unit battery, the locking part is released from the catching part and the contact part is upwardly and elastically repulsed, such that the first contact may be released from the second contact, and the battery relay may be turned off.

The unit battery may be a battery cell or a battery module.

According to another exemplary embodiment of the present disclosure, an apparatus for preventing over-charge for a battery of a vehicle is provided. The apparatus includes a pair of operating parts disposed between adjacent unit batteries, having one end portion having a pair of catching parts disposed thereon, having a first contact disposed on an upper end of one or more catching parts, and contacting the respective unit batteries to which the other end portions correspond, respectively. A contact part may have a locking part disposed therein, the locking part is tightly fixed by the pair of catching parts and may include a second contact contacting the first contact. The contact part may be upwardly and elastically supported by an elastic part, and an elastic repulsion toward an upper direction is interrupted by fastening the pair of catching parts and the locking part. A battery relay may turn on and off a battery current and may be connected to an operating power source by joining the first contact and the second contact.

If the pair of operating parts are adjacent to each other by a swelling of the unit battery, the locking part is released from the pair of catching parts, and the contact part is upwardly and elastically repulsed, such that the first contact may be released from the second contact, and the battery relay may be turned off.

The other end portions of the pair of operating parts may be extended to corresponding unit battery sides and may be supported, and the catching parts protruded to the corresponding unit battery sides may be disposed at one end portion of the pair of operating parts.

The contact part may have both ends extended from an upward direction of the pair of operating parts to a downward direction thereof and may have the locking part protruded at the respective end portions, wherein the locking part may be tightly fixed by the pair of catching parts.

The elastic part may upwardly press the locking part in a state in which a lower end thereof is supported on the pair of operating parts.

The elastic part may upwardly press the contact part in a state in which a lower end thereof is supported on the pair of operating parts.

The unit battery may be an adjacent battery module.

According to another exemplary embodiment of the present disclosure, an apparatus for preventing over-charge for a battery of a vehicle is provided. The apparatus includes a pair of operating parts disposed between adjacent unit batteries and a battery housing, having one end portion on which catching parts are disposed, having a first contact disposed on an upper end of one or more catching parts, and contacting the unit battery and battery housing to which the other end portions correspond, respectively. A contact part has a locking part disposed therein, the locking part may be fixed by the pair of catching parts, and includes a second contact contacting the first contact. The contact part may be upwardly and elastically supported by an elastic part, and an elastic repulsion toward an upper direction may be interrupted by fastening the catching parts and the locking part. A battery relay may turn on and off a battery current and may be connected to an operating power source by joining the first contact and the second contact.

### BRIEF DESCRIPTION OF THE DRAWINGS

FIGS. 1 to 3 are views showing operation processes of an apparatus for preventing over-charge for a battery of a vehicle according to an exemplary embodiment of the present disclosure.

FIGS. 4 and 5 are views showing another apparatus for preventing over-charge for a battery of a vehicle according to an exemplary embodiment of the present disclosure.

FIG. 6 is a view showing a relay of an apparatus for preventing over-charge for a battery of a vehicle according to an exemplary embodiment of the present disclosure.

### DETAILED DESCRIPTION

Exemplary embodiments of the present disclosure will now be described in detail with reference to the accompanying drawings.

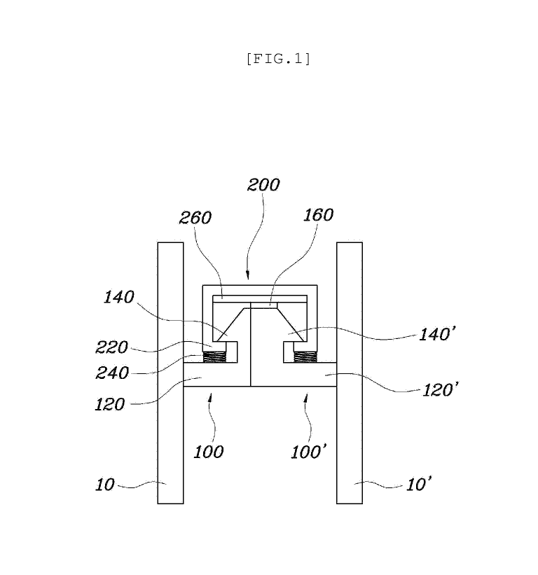

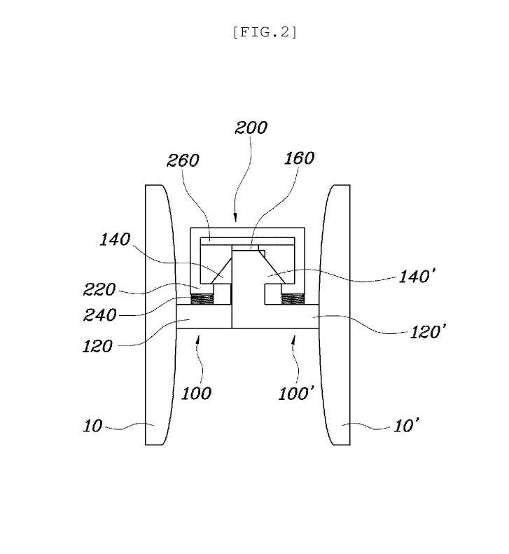

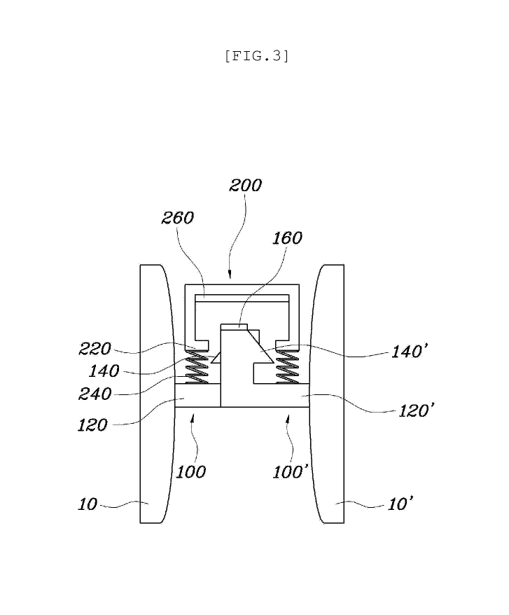

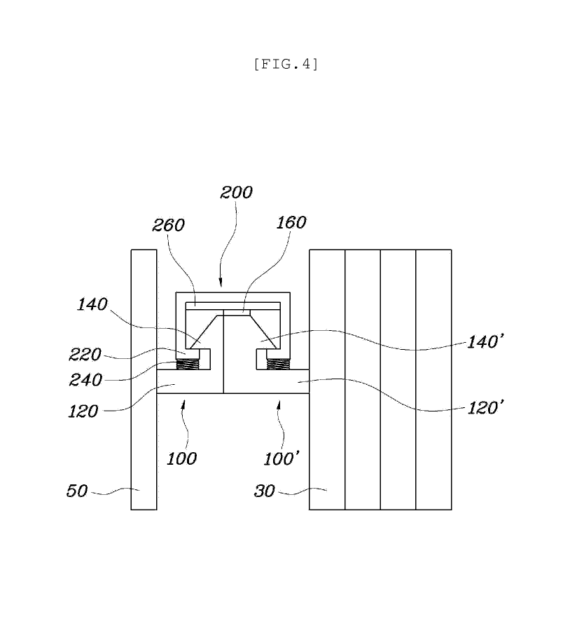

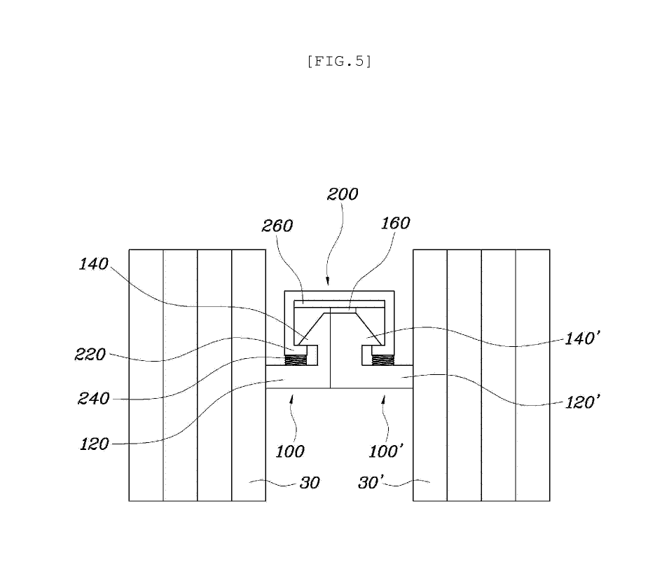

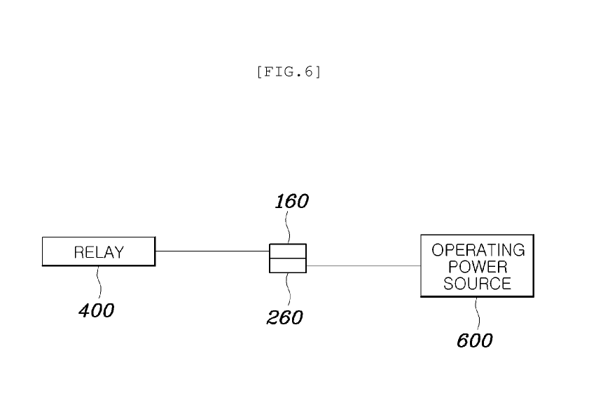

FIGS. 1 to 3 are views showing operation processes of an apparatus for preventing over-charge for a battery of a vehicle according to an exemplary embodiment of the present disclosure. FIGS. 4 and 5 are views showing another apparatus for preventing over-charge for a battery of a vehicle according to an exemplary embodiment of the present disclosure. FIG. 6 is a view showing a relay of an apparatus for preventing over-charge for a battery of a vehicle according to an exemplary embodiment of the present disclosure.

According to the present disclosure, in the case in which a current is continuously applied to a battery in an abnormal state, a cell is out of a normal state to thereby be swelled. When the cell is swelled, the cell presses a switch disposed between modules or cells from both sides, such that a contact to which a wire supplying power to a relay is connected is separated. Since the power is not supplied to the relay, the relay serving as the switch is turned off. The current, which is applied to the battery, does not flow any longer, thereby preventing the over-charge.

FIG. 6 is a view showing a relay of an apparatus for preventing over-charge for a battery of a vehicle according to an exemplary embodiment of the present disclosure, wherein the relay in the vehicle serves as a switch for a large current flow (power line). The relay becomes a turned-on state in the case in which an operating power source (about 10V to 14V) is applied and becomes a turned-off state in the case in which the operating power source is removed. The relay is in the turned-on state when the battery is operated normally (charged and discharged) and is the turned-off state when the battery is not operated.

In the case in which the current is continuously applied to the battery in an abnormal state, a voltage is increase and the battery is swelled. The switch having a middle portion of a wire, which supplies power to the relay as a contact, is positioned in a space in which the cell in a module or a pack is swelled. When the cell is over-charged to thereby be swelled, it presses both sides of the switch, such that the contact is separated. The power is then no longer supplied to the relay and the relay becomes the turned-off state. Since the relay serves as the switch of the entire power line when it is in the turned-off state, the current no longer flows, and the battery is no longer over-charged.

An apparatus for preventing over-charge for a battery of vehicle according to an exemplary embodiment of the present disclosure may include an operating part 100 having one end portion having a catching part 140 disposed thereon. A first contact 160 is disposed on an upper end of the catching part 140, and the other end portion 120 contacts a unit battery. A contact part 200 has a locking part 220 disposed therein, wherein the locking part 220 is tightly fixed by the catching part 140. The contact part 200 further includes a second contact 260 contacting the first contact 160. The contact part 200 is upwardly and elastically supported by an elastic part 240, and an elastic repulsion toward an upper direction is interrupted by fastening the catching part 140 and the locking part 220. A battery relay 400 turns on and off a battery current and is connected to an operating power source 600 by joining the first contact 160 and the second contact 260.

FIGS. 1 to 3 are views showing operation processes of an apparatus for preventing over-charge for a battery of a vehicle according to an exemplary embodiment of the present disclosure. In the case in which the operating part 100 is slid due to swelling of the unit battery, the locking part 220 is released from the catching part 140, and the contact part 200 is upwardly and elastically repulsed, such that the joint between the first contact 160 and the second contact 260 is released, thereby making it possible to turn off the battery relay 400.

As shown in FIGS. 1 to 3, the unit battery may be battery cells 10 and 10′, or may be a battery module.

Specifically, other end portions of a pair of operating parts 100 and 100′ are extended to corresponding unit battery sides and are supported. The catching parts 140 and 140′ protruded to the corresponding unit battery sides may be disposed at one end portion of the operating parts 100 and 100′. The contact part 200 may have both ends extended from an upward direction of the operating parts 100 and 100′ to a downward direction and may have the locking part 220 protruded at respective end portions, wherein the locking part 220 is fixed by the catching parts 140 and 140′. The elastic part 240 may upwardly press the locking part in a state in which a lower end thereof is supported by the operating parts 100 and 100′.

Therefore, in the case in which the battery cells 10 and 10′ are swelled, the other end of each of the operating parts 100 and 100′ is pressed and slid, such that the locking part 220 is released form the catching parts 140 and 104′, the contact part is upwardly and elastically repulsed by the elastic part 240, and the joint between the first contact 160 and the second contact 260 is released. Thereby, power of the operating power source 600 is no longer applied, such that the battery relay 400 is turned off, and the current is no longer supplied to the battery, and thereby, charging is stopped.

FIGS. 4 and 5 are views showing another apparatus for preventing a vehicle battery from overcharging according to an exemplary embodiment of the present disclosure. An apparatus for preventing the over-charge for the battery shown in FIG. 4 may include a pair of operating parts 100 and 100′ between a battery module 30 as an adjacent unit battery and a battery housing 50, having one end portion having catching parts 140 and 140′ disposed thereon, having a first contact 160 disposed on an upper end of one or more catching parts 140 and 140′, and contacting the unit battery and the battery housing to which the other end portions correspond, respectively. A contact part 200 has a locking part 220 disposed therein, and the locking part 220 is tightly fixed by a pair of catching parts 140 and 140′. The contact part 200 includes a second contact 260 contacting the first contact 160 and is upwardly and elastically supported by an elastic part 240. An elastic repulsion toward an upper direction is interrupted by fastening the catching parts 140 and 140′ and the locking part 220. A battery relay 400 turns on and off a battery current and is connected to an operating power source 600 by joining the first contact 160 and the second contact 260.

An apparatus for preventing a battery of vehicle from overcharging shown in FIG. 5 may include a pair of operating parts 100 and 100′ between both battery modules 30 and 30′ as an adjacent unit battery, having one end portion having catching parts 140 and 140′ disposed thereon, having a first contact 160 disposed on an upper end of one or more catching parts 140 and 140′, and contacting the respective unit battery to which the other end portions 120 and 120′ correspond, respectively. A contact part 200 has a locking part 220 disposed therein, and the locking part 220 is fixed by the pair of catching parts 140 and 140′. The contact part 200 includes a second contact 260 contacting the first contact 160 which is upwardly and elastically supported by an elastic part 240, and an elastic repulsion toward an upper direction is interrupted by fastening the catching parts 140 and 140′ and the locking part 220. A battery relay 400 turns on and off a battery current and is connected to an operating power source 600 by joining the first contact 160 and the second contact 260.

In the case in which the pair of operating parts 100 and 100′ are adjacent to each other by a swelling of the unit battery, the fixing structure between the catching parts 140 and 140′ and the locking part 220 is released and the contact part 200 is upwardly and elastically repulsed, such that the joint between the first contact 160 and the second contact 260 is released, thereby making it possible to turn off the battery relay 400.

The other end portions 120 and 120′ of the operating parts 100 and 100′ are extended to corresponding unit battery sides and are supported. The catching parts 140 and 140′ protruded to the corresponding unit battery sides may be disposed at one end portion of the operating parts 100 and 100′. In addition, the contact part 200 may have both ends extended from an upward direction of the pair of operating parts 100 and 100′ to a downward direction thereof and may have the locking part 220 protruded at the respective end portions, wherein the locking part 220 is fixed by the catching parts 140 and 140′. In addition, the elastic part 240 may upwardly press the locking part 220 in a state in which a lower end thereof is supported on the operating parts 100 and 100′.

According to the apparatus for preventing over-charge for the battery of the vehicle configured by the structure as described above, the voltage operating the relay may be simply blocked using swelling force of the cell in the battery module or the battery pack.

Since the present disclosure is based on the mechanical design, the relay may be turned off even in the case in which the over-charge is generated when the BMS or the vehicle (HCU/ECU) is in the abnormal state.

Although the present disclosure is shown and described in connection with the specific embodiments, it is apparent to those skilled in the art that the modifications and variations can be made without departing from the spirit and scope of the disclosure as defined by the appended claims.

What is claimed is:

1. An apparatus for preventing over-charge for a battery of a vehicle, the apparatus comprising:
an operating part having one end portion on which a catching part is disposed, a first contact disposed on an upper end of the catching part, and the other end portion contacting a unit battery;
a contact part having a locking part disposed therein, the locking part being tightly fixed by the catching part, the contact part including a second contact contacting the first contact, and upwardly and elastically supported by an elastic part and interrupting an elastic repulsion toward an upper direction by fastening the catching part and the locking part; and
a battery relay turning on and off a battery current and connected to an operating power source by joining the first contact and the second contact.

2. The apparatus of claim 1, wherein when the operating part is slid by a swelling of the unit battery, the locking part is released from the catching part and the contact part is upwardly and elastically repulsed, such that the first contact is released from the second contact and the battery relay is turned off.

3. The apparatus of claim 1, wherein the unit battery is a battery cell.

4. The apparatus of claim 1, wherein the unit battery is a battery module.

5. An apparatus for preventing over-charge for a battery of a vehicle, the apparatus comprising:
a pair of operating parts disposed between adjacent unit batteries, the pair of operating parts having one end portion on which a pair of catching parts are disposed, a first contact is disposed on an upper end of one or more catching parts, and contacting the respective unit batteries to which other end portions correspond, respectively;
a contact part having a locking part disposed therein, the locking part being tightly fixed by the pair of catching parts, including a second contact contacting the first contact, and upwardly and elastically supported by an elastic part and interrupting an elastic repulsion toward an upper direction by fastening between the pair of catching parts and the locking part; and
a battery relay turning on and off a battery current and connected to an operating power source by joining the first contact and the second contact.

6. The apparatus of claim 5, wherein if the pair of operating parts are adjacent to each other by a swelling of the unit battery, the locking part is released from the pair of catching parts and the contact part is upwardly and elastically repulsed, such that the first contact is released from the second contact and the battery relay is turned off.

7. The apparatus of claim 5, wherein the other end portions of the pair of operating parts are extended to corresponding unit battery sides and are supported, and the catching parts protruded to the corresponding unit battery sides are disposed at one end portion of the pair of operating parts.

8. The apparatus of claim 7, wherein the contact part has both ends extended from an upward direction of the pair of operating parts to a downward direction thereof and has the locking part protruded at the respective end portions, the locking part being caught by the catching parts.

9. The apparatus of claim 8, wherein the elastic part upwardly presses the locking part in a state in which a lower end thereof is supported by the pair of operating parts.

10. The apparatus of claim 5, wherein the elastic part upwardly presses the contact part in a state in which a lower end thereof is supported by the pair of operating parts.

11. The apparatus of claim 5, wherein the unit battery is an adjacent battery module.

12. An apparatus for preventing over-charge for a battery of a vehicle, the apparatus comprising:
a pair of operating parts disposed between adjacent unit batteries and a battery housing, the pair of operating parts having one end portion on which a pair of catching parts are disposed, having a first contact disposed on an upper end of one or more catching parts, and contacting the unit battery and battery housing to which other end portions correspond, respectively;
a contact part having a locking part disposed therein, the locking part being tightly fixed by the pair of catching parts, including a second contact contacting the first contact, and upwardly and elastically supported by an elastic part and interrupting an elastic repulsion toward an upper direction by fastening the catching parts and the locking part; and
a battery relay turning on and off a battery current and connected to an operating power source by joining the first contact and the second contact.
